(19) United States
(12) Patent Application Publication
(10) Pub. No.: US 2026/0356252 A1
(43) Pub. Date: Nov. 12, 2026

(54) LONGITUDINAL ADJUSTER, VEHICLE SEAT

(71) Applicant: Adient US LLC, Plymouth, MI (US)

(72) Inventors: Erik SPRENGER, Wermelskirchen (DE); Ingo QUAST, Düsseldorf (DE)

(73) Assignee: Adient US LLC, Plymouth, MI (US)

(21) Appl. No.: 19/120,902

(22) PCT Filed: Feb. 3, 2023
(86) PCT No.: PCT/IB2023/050954

§ 371 Date: Apr. 14, 2025

(30) Foreign Application Priority Data
Oct. 14, 2022 (DE) 10 2022 210 865.5

(51) Int. Cl. B60N 2/06; B60N 2/02; B60N 2/427

(52) U.S. Cl. CPC B60N 2/067; B60N 2/02253; B60N 2/42736

(57) ABSTRACT

A longitudinal adjuster for a vehicle seat may have at least a rail pair which is formed from a first rail and a second rail which are designed to be movable in a longitudinal direction relative to one another. The adjuster may also have a drive device which is formed at least from a motor and a spindle nut that is driven by means of the motor and is arranged so as to be longitudinally movable on a fixed spindle. The rails may mutually engage around one another, forming an internal channel. A spindle holder may be arranged in the internal channel. The spindle holder may be connected to one of the rails on one side and to the spindle on the other. The at least one spindle holder may be movably mounted on this rail. A vehicle seat having such a longitudinal adjuster is also provided.

The invention concerns a longitudinal adjuster, in particular for a vehicle seat. The invention furthermore concerns a vehicle seat.

### PRIOR ART

Longitudinal adjusters, in particular for a vehicle seat, are known from the prior art. The longitudinal adjusters usually have at least one rail pair, which is formed from a first rail and a second rail that is displaceable in the longitudinal direction relative to the first rail, and at least one drive device which is formed at least from a motor and a spindle that is drivable by means of the motor, or a drivable spindle nut with trapezoid thread. The rails mutually engage around one another to form an inner channel. A spindle holder connected to the second rail is arranged in the inner channel and connected to the spindle.

In reaction to a force application, in particular in the forward direction, for example in the case of a crash or incorrect use, deformations of the spindle may occur so that the seat cannot be adjusted in an emergency.

### OBJECT

The invention is based on the object of improving a longitudinal adjuster of the type cited initially, in particular of reducing or avoiding a permanent deformation of the spindle after overload, and of providing a corresponding vehicle seat.

### SOLUTION

The first said object is achieved according to the invention by a longitudinal adjuster with the features of claim 1. The second said object is achieved according to the invention by a vehicle seat with the features of claim 10.

Advantageous embodiments, which may be used individually or in combination with one another, are the subject of the dependent claims.

The longitudinal adjuster according to the invention, in particular for a vehicle seat, comprises at least a rail pair which is formed from a first rail and a second rail, which are configured so as to be displaceable in the longitudinal direction relative to one another, and a drive device which is formed at least from a motor and a spindle nut, which is drivable by means of the motor and is arranged so as to be longitudinally movable on an in particular stationary spindle, wherein the rails mutually engage around one another to form an inner channel, wherein at least one spindle holder is arranged in the inner channel and is connected on one side to one of the rails and on the other to the spindle. According to the invention, the at least one spindle holder is movably mounted on this rail.

A first rail may preferably be a seat rail, in particular a top rail, which can be connected to the vehicle seat. A second rail may preferably be a floor rail, in particular a lower rail, which can be connected to a vehicle structure. The at least one spindle holder may preferably be movably mounted on the second rail.

In reaction to a predefined force application, for example during an accident, a force may be conducted away from the vehicle seat via the first rail, the spindle nut, the spindle and the spindle holder, to the second rail.

The invention is based on the consideration that even after an accident, in particular when high longitudinal loads act on the longitudinal adjuster, the vehicle seat must still allow an adjustment of the movable rail (=first rail) and hence of the vehicle seat, for example for an emergency exit from a seat row situated behind the vehicle seat. To ensure this, the longitudinal adjuster is designed not to distort or buckle the spindle at least in the front region, viewed in the longitudinal direction, between the spindle holder and the spindle nut and/or a gear mechanism of the motor.

The invention is furthermore based on the consideration that under a high rail longitudinal load, for example in the forward direction, tensile forces act on the spindle in the rear spindle region between the spindle nut/gear mechanism of the motor and a rear spindle holder in the fixed rail (=second rail, also called lower rail), and compression forces act on the spindle in the front spindle region between the spindle nut/gear mechanism of the motor and a front spindle holder. If a specific force is exceeded, this can lead in the rear region of the spindle to both an elastic and also plastic elongation, and in the front region of the spindle to an elastic or permanent lateral deviation of the spindle, which results in undesired bending and/or buckling of the spindle. Thus the spindle nut (also called the output gear wheel), which stands in active interconnection with the spindle, can no longer rotate inside the gear mechanism in the region of the undesired bending and/or buckling, so that a longitudinal adjustment is prevented or blocked.

Because at least one of the spindle holders, in particular a front spindle holder viewed in the longitudinal direction, is movably mounted on the second rail, in particular the fixed rail or the lower rail, such undesired deformations, such as for example distortion and/or buckling of the spindle in the front region, are at least reduced or simply do not occur at all and are thus prevented. In other words, the invention allows the avoidance of spindle deformations under a high longitudinal load.

In particular, the spindle holder is linearly movably, for example longitudinally movably, mounted on the-in particular, second-rail. A longitudinally movable mounting of the spindle holder means in particular a linear movement of the spindle holder in the longitudinal direction of the rails, along a longitudinal axis or rail axis.

For fastening the spindle holder to the second rail, for example at least two fastening elements may be provided. The second rail may, for example, have at least two fastening receivers, in which the at least two fastening elements are movably mounted. In particular, the fastening receivers are configured such that the fastening elements are mounted with limited linear movability.

For example, the fastening receiver is designed to block the linear movement of the fastening element in one direction. In an opposite direction, the fastening element is designed to allow a limited linear movement of the fastening element.

The respective fastening receiver may for example comprise a stop or block, wherein on application of a force, the linear movement of the fastening element is blocked by the stop or block. In addition, the respective fastening receiver may be designed such that, starting from a normal position, the fastening element is linearly movable in the case of a mechanical stress on the second rail in the direction of a compensation position, in particular in the direction of the acting force, for example directed toward the front in the longitudinal direction, and is longitudinally movable.

For example, the respective fastening receiver may be configured as a slot in the second rail. Such an embodiment of the respective fastening receiver as a slot allows a linear longitudinal movability with simultaneous fixing of the lateral position of the fastening element in the fastening receiver. In addition, the at least two fastening receivers may be oriented in the same way in the longitudinal direction.

The respective spindle holder, in particular the front spindle holder and/or the rear spindle holder, may be connected to the second rail, in particular the lower rail, via the fastening elements. The lower rail may be fastened to a vehicle floor or to a vehicle body. The second rail is fixedly connected to the vehicle floor or vehicle body in the vertical direction. The fastening elements are for example configured as rivets.

The spindle may be connected to the second rail via the spindle holder. The spindle is configured as a stationary spindle. Optionally, an attachment plate may be arranged between the spindle holder and the second rail. In particular, the optional attachment plate may be arranged on the front spindle holder, viewed in the longitudinal direction, between the front spindle holder and the second rail. The attachment plate may be configured in a U-shape as a further mounting. The spindle holder is then connected to the attachment plate at the bottom of the U-shape. For example, the spindle is connected via the spindle holder to the attachment plate by a material bond, for example by means of a weld connection. The attachment plate may, however, also be omitted and the spindle holder fastened directly to a bottom of the second rail.

The respective spindle holder may be riveted to the second rail, such that a limited linear movement of the spindle holder relative to the second rail is permitted on exceeding of a predefined force, occurring in the longitudinal direction.

In order to still allow this longitudinal movability after a riveting process, a spring element may be provided. For example, a spring element with predefined pretension may be arranged between the spindle holder and the second rail. The spring element is formed for example as a cup spring. Here, the fastening elements, the fastening receiver, the attachment plate and the spring element are configured and arranged relative to one another such that the spring element is arranged with a defined pretension and without seizing between the fastening head (=rivet head) and the underside of the second rail. This may avoid a rattling of the spindle holder during travel.

By means of the spring element, a predefined friction force may be generated between the spindle holder and the second rail, so that in normal operation, on a longitudinal adjustment, the spindle holder is securely fixed to and positioned on the second rail, and is only movable in the longitudinal direction relative to the second rail in the case of an accident or incorrect use, and if the predefined friction force is exceeded.

The fastening receiver, configured as a slot, allows a longitudinal movement of the spindle holder and of the optional attachment plate, together with the fastening elements, toward the front in the longitudinal direction relative to the second rail. Toward the rear in the longitudinal direction, the fastening elements in the fastening receiver hit in particular against a stop or block. Thereby, tensile forces can be absorbed without displacement of the attachment plate and/or spindle holder. In other words, tensile forces are transmitted directly into the second rail (=lower rail) via the stop or block in the fastening receiver. Compression forces cannot initially be transmitted since the spindle holder and fastening elements can deviate forwards in the longitudinal direction, in the fastening receiver which is configured as a slot.

In other words, the slot and the fastening elements, such as rivets, are in each case positioned relative to one another in the longitudinal direction or x direction, so that in one direction (here backwards), no displacement is possible on overload, but in the opposite direction (here forwards), displacement is possible on occurrence of a high force.

The spindle is stationary. The spindle nut is mounted on the spindle so as to be rotationally movable and longitudinally movable, and is drivable by means of the motor.

The external thread of the spindle may be structured in the form of a trapezoid thread. The internal thread of the spindle nut may be structured in the form of a trapezoid thread. The external thread of the spindle and internal thread of the spindle nut may each be structured as a double thread.

The longitudinal adjuster may preferably comprise two spindle holders, in particular a front spindle holder and a rear spindle holder. The spindle nut is longitudinally movably mounted on the spindle between the front spindle holder and the rear spindle holder.

The object is furthermore achieved according to the invention by a vehicle seat with a longitudinal adjuster according to the invention, in particular a longitudinal adjuster according to the above description.

### FIGURES AND EMBODIMENTS OF THE INVENTION

The invention is explained in more detail with reference to advantageous exemplary embodiments shown in the figures. The invention is not however restricted to these exemplary embodiments. In the drawings:

FIG. 1: shows a schematic illustration of a vehicle seat with a longitudinal adjuster,

FIG. 2: shows a section, along line II-II of FIG. 1, of a longitudinal adjuster according to the invention, and

FIG. 3: shows an enlarged sectional illustration, in the region III of FIG. 2, of a spindle holder of the longitudinal adjuster according to the invention.

Mutually corresponding parts are provided with the same reference signs in all figures.

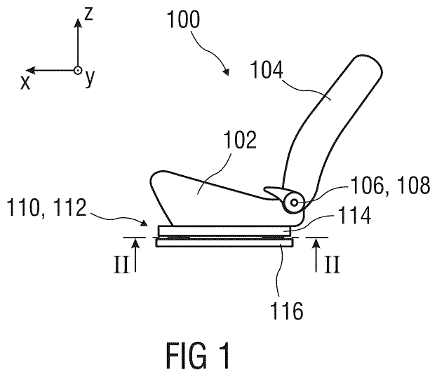

A vehicle seat 100 of the prior art, shown schematically in FIG. 1, is described below with reference to three spatial directions running perpendicularly to one another. With a vehicle seat 100 installed in the vehicle, a longitudinal direction x runs largely horizontally and preferably parallel to a vehicle longitudinal direction, which corresponds to the usual direction of travel of the vehicle. A transverse direction y, running perpendicularly to the longitudinal direction x, is also oriented horizontally in the vehicle and runs parallel to a vehicle transverse direction. A vertical direction z runs perpendicularly to the longitudinal direction x and perpendicularly to the transverse direction y. When a vehicle seat 100 is installed in the vehicle, the vertical direction z preferably runs parallel to a vehicle vertical axis.

The positional data and/or directional data used, such as for example front, rear, top and bottom, relate to a viewing direction of an occupant seated in the vehicle seat 100 in the normal seating position, wherein the vehicle seat 100 is installed in the vehicle in a usage position suitable for transport of persons, with an upright backrest 104, and oriented, in the conventional fashion, in the direction of travel. The vehicle seat 100 may, however, also be fitted or moved in a different orientation, for example transversely to the direction of travel. Unless described otherwise, the vehicle seat 100 is constructed so as to be mirror-symmetrical to a plane running perpendicularly to the transverse direction y.

The backrest 104 may be arranged pivotably on a seating part 102 of the vehicle seat 100. For this, the vehicle seat 100 may optionally comprise a control fitting 106, in particular an adjustment control fitting, rotary control fitting, latching control fitting or thumbwheel control fitting.

The positional data and/or directional data used, such as for example radial, axial and circumferential, relate to a rotational axis 108 of the control fitting 106. Radial means perpendicular to the rotational axis 108. Axial means in the direction of or parallel to the rotational axis 108.

The vehicle seat 100 comprises a longitudinal adjuster 110 (also called a longitudinal adjustment device). The longitudinal adjuster 110 comprises for example a rail arrangement 112 with a first rail 114 and a second rail 116. The first rail 114 is adjustable in the longitudinal direction x relative to the second rail 116. The first rail 114 is fastened to the seating part 102. The second rail 116 is fastened to a structural element of a vehicle, for example a vehicle floor.

For greater clarity, in the description which follows, the first rail 114 is called the top rail 114. This top rail 114 (also called a running rail or slide) is assigned to the vehicle seat 100 and designed to carry this vehicle seat 100. The second rail 116 is referred to below as the lower rail 116. The lower rail 116 is fixed and, for example, connected to the floor of a vehicle.

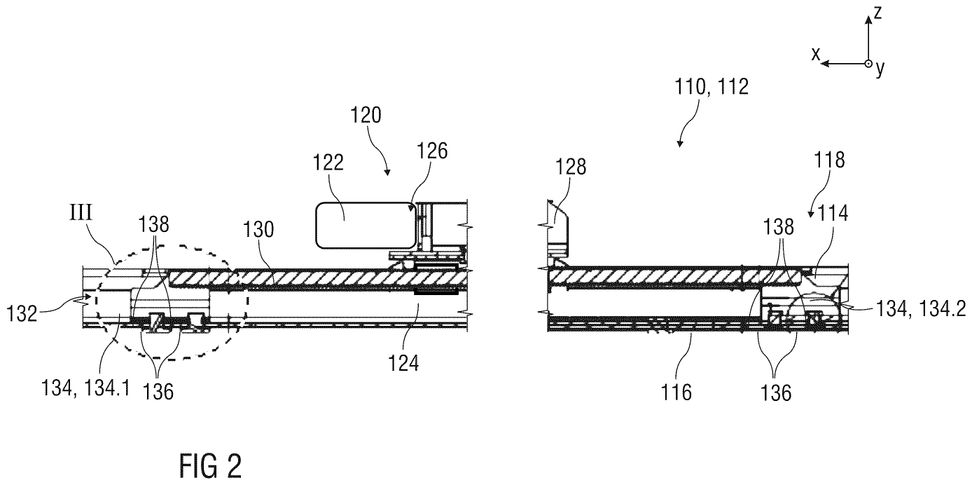

FIG. 2 shows a section in the x-z plane, along line II-II in FIG. 1, of a longitudinal adjuster 110 according to the invention, which comprises the rail arrangement 112 and a drive device 120.

The rail arrangement 112 of the vehicle seat 100 may comprise two rail pairs 118 which are arranged parallel to one another. Each rail pair 118 comprises the fixed lower rail 116 and the top rail 114, which is arranged longitudinally movably thereon.

FIG. 2 shows as an example one of the rail pairs 118.

The longitudinal adjuster 110 comprises the rail arrangement 112 with two rail pairs 118 and the drive device 120, which is formed at least from a motor 122 and a spindle nut 124, which is drivable by means of the motor 122. A gear mechanism 126 may be arranged between the motor 122 and the spindle nut 124. The vehicle seat 100 is fixedly connected to the longitudinal adjuster 110 by means of at least one seat holder 128.

The spindle nut 124 is longitudinally movably arranged on a spindle 130. The spindle 130 is stationary. The spindle nut 124 is mounted on the spindle 130 so as to be rotationally movable and longitudinally movable, and is drivable by means of the motor 122 via the gear mechanism 126.

The lower rail 116 and the top rail 114 may mutually engage around one another to form an inner channel 132. A spindle mounting, connected to the lower rail 116, is arranged in the inner channel 132. The spindle mounting may comprise one or more spindle holders 134. The spindle mounting comprises a front spindle holder 134.1 and a rear spindle holder 134.2. The spindle nut 124 is longitudinally movably mounted on the spindle 130, between the front spindle holder 134.1 and the rear spindle holder 134.2.

According to the invention, at least one spindle holder 134 is movably mounted on the lower rail 116 (=fixed rail, second rail).

In particular, the front spindle holder 134.1 may be mounted on the lower rail 116 so as to be linearly movable, for example longitudinally movable.

For fastening the—in particular, linearly movable—spindle holder 134 to the lower rail 116, for example two fastening elements 138, in particular rivets, may be provided. The lower rail 116 may for example have at least two fastening receivers 136, each for one spindle holder 134. The at least two fastening elements 138 are movably mounted in the fastening receivers 136.

The respective spindle holder 134 is connected to the fixed lower rail 116 via the fastening elements 138. The fastening elements 138 are, for example, formed as rivets.

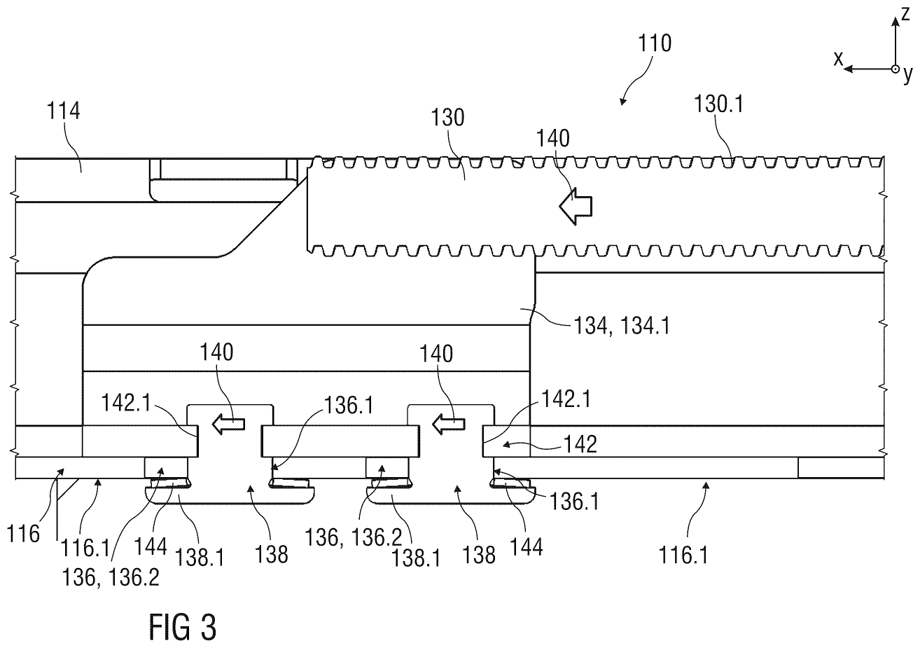

In reaction to a predefined force application, for example during an accident, a force can be conducted away from the vehicle seat 100 via the top rail 114, the spindle nut 124, the spindle 130 and the respective spindle holder 134, into the lower rail 116, as will be described below in detail, as an example, with reference to FIG. 3.

FIG. 3 shows an enlarged sectional illustration, in region III of FIG. 2, of the front spindle holder 134.1 of the longitudinal adjuster 110 according to the invention.

The fastening receivers 136 in the lower rail 116 are configured such that the fastening elements 138 are mounted so as to be limitedly linearly movable, in particular limitedly longitudinally movable, forwards according to arrow 140.

For example, the respective fastening receiver 136 is designed to block the linear movement of the associated fastening element 138 in one direction.

For this, the respective fastening element 138, in particular a rivet, lies against a stop 136.1. In addition, the respective fastening receiver 136 is designed to allow a limited linear movement of the associated fastening element 138 in the opposite direction, according to arrow 140. For this, the respective fastening receiver 136 is configured, for example, as a slot 136.2 in the lower rail 116. In other words, the respective fastening receiver 136 has larger dimensions in the longitudinal direction x than the outer dimensions of the associated fastening element 138.

Such an embodiment of the respective fastening receiver 136 as a slot 136.2 allows a linear longitudinal movability with simultaneous fixing of the lateral position of the associated fastening element 138 in the fastening receiver 136.

The two fastening receivers 136 of the front spindle holder 134.1 are oriented in the same way in the longitudinal direction x. The two fastening receivers 136 are arranged spaced apart from one another.

The spindle 130 may be connected to the lower rail 116 via the front spindle holder 134.1, or optionally to the lower rail 116 via an attachment plate 142, as shown as an example. The attachment plate 142 comprises passage openings 142.1 for the fastening elements 138. The passage openings 142.1 correspond to the outer dimensions of the fastening elements 138.

For example, the spindle 130 is connected to the front spindle holder 134.1 by a material bond, for example by means of a weld connection.

The front spindle holder 134.1 is riveted to the lower rail 116 such that, on exceeding of a predefined force occurring in the longitudinal direction x, according to arrow 140, a linear movement of the front spindle holder 134.1 relative to the lower rail 116 is permitted.

In order to still allow this longitudinal movability after a riveting process, for example a spring element 144 is provided. For example, the spring element 144 may be arranged with predefined pretension between the front spindle holder 134.1 and the lower rail 116. The spring element 144 is formed for example as a cup spring.

The fastening elements 138, in particular rivets, are fixedly connected, in particular riveted, to the respective spindle holder 134.

The fastening elements 138, the fastening receivers 136, the optional attachment plate 142 and the spring element 144, are in particular configured and arranged relative to one another such that the spring element 144 is arranged with a defined pretension and without seizing between a fastening head 138.1 (=rivet head) and an underside 116.1 of the lower rail 116. The step height of the fastening head 138.1 together with the height of the spring element 144, for example a cup spring, defines the pretension force in the vertical direction z. In addition, the fastening elements 138, the fastening receivers 136, the optional attachment plate 142 and the spring element 144, are designed such that a seizing of the spring element 144, in particular the cup spring, is avoided. Thus the longitudinal movability of the spindle holder 134 is further enabled and not restricted or obstructed. Thereby, furthermore, a rattling of the front spindle holder 134.1 during travel can be avoided.

By means of the spring element 144, a predefined friction force may be generated between the front spindle holder 134.1 and the lower rail 116, so that in normal operation, on a longitudinal adjustment, the front spindle holder 134.1 is securely fixed to and firmly positioned on the lower rail 116. In the case of an accident or incorrect use, during which greater forces occur in the longitudinal direction x, and on exceeding of the predefined friction force in the longitudinal direction x relative to the lower rail 116, the spring element 144 allows the front spindle holder 134.1, via its fastening elements 138 in the fastening receivers 136, to be limitedly longitudinally movable, in particular forwards according to arrow 140.

The fastening receiver 136, configured as a slot 136.2, thus allows a limited longitudinal movement of the front spindle holder 134.1 and of the optional attachment plate 142, together with the fastening elements 138, towards the front in the longitudinal direction x relative to the fixed lower rail 116. Towards the rear in the longitudinal direction x, the fastening elements 138 in the fastening receiver 136 hit against the respective stop 136.1 or block.

In other words, tensile forces are transmitted directly into the lower rail 116 via the stop 136.1 in the fastening receiver 136. Compression forces cannot initially be transmitted, since the front spindle holder 134.1 and fastening elements 138 can deviate forwards in the longitudinal direction x, in the fastening receiver 136 configured as a slot 136.2. The slot 136.2 and fastening elements 138, such as rivets, are each positioned relative to one another in the longitudinal direction x so that in one direction (here backwards, opposite the arrow 140), no displacement is possible on overload, but in the opposite direction (here forwards, according to arrow 140), displacement is possible under occurrence of a high force.

An external thread 130.1 of the spindle 130 may be structured in the form of a trapezoid thread. An internal thread (not shown in detail) of the spindle nut 124 may be structured in the form of a trapezoid thread. The external thread 130.1 of the spindle 130 and the internal thread of the spindle nut 124 may each be structured as a double thread.

The features disclosed in the above description, the claims and the figures may be important to the implementation of the invention in its various embodiments, both individually and also in combination.

Although the invention has been described in detail in the figures and in the preceding presentation, the depictions are illustrative and exemplary and should not be understood restrictively. In particular, the choice of the proportions of the individual elements, shown in the drawing, should not be interpreted as necessary or restrictive. Furthermore, the invention is in particular not restricted to the exemplary embodiments presented. Further variants of the invention and its implementation will arise for the person skilled in the art from the preceding disclosure, the figures and the claims.

In the claims, terms used such as “comprise”, “have”, “contain”, “include” and similar do not exclude further elements or steps. The use of the indefinite article does not exclude a plurality. A single device may perform the functions of several units or devices cited in the claims.

### LIST OF REFERENCE SIGNS

100 Vehicle seat
102 Seating part
104 Back rest
106 Control fitting
108 Rotational axis
110 Longitudinal adjuster
112 Rail arrangement
114 First rail (top rail)
116 Second rail (lower rail)
116.1 Underside
118 Rail pair
120 Drive device
122 Motor
124 Spindle nut
126 Gear mechanism
128 Seat holder
130 Spindle
130.1 External thread
132 Inner channel
134 Spindle holder
134.1 Front spindle holder
134.2 Rear spindle holder
136 Fastening receiver
136.1 Stop
136.2 Slot
138 Fastening element
138.1 Fastening head
140 Arrow
142 Attachment plate
142.1 Passage opening
144 Spring element
x Longitudinal direction
y Transverse direction
z Vertical direction

1-10. (canceled)

11. A longitudinal adjuster for a vehicle seat, wherein the longitudinal adjuster comprises:
a rail pair which is formed from a first rail and a second rail, which are configured so as to be displaceable in the longitudinal direction relative to one another, and
a drive device which is formed at least from a motor and a spindle nut, which is drivable by means of the motor and is arranged so as to be longitudinally movable on a spindle,
wherein the rails mutually engage around one another to form an inner channel,
wherein at least one spindle holder is arranged in the inner channel, and is connected on one side to one of the rails and on the other to the spindle, and
wherein the at least one spindle holder is movably mounted on this rail.

12. The longitudinal adjuster as claimed in claim 11, wherein the at least one spindle holder is linearly movably mounted on this rail.

13. The longitudinal adjuster as claimed in claim 11, wherein for fastening the at least one spindle holder on this rail, at least two fastening elements are provided, and this rail has at least two fastening receivers, in which the at least two fastening elements are movably mounted.

14. The longitudinal adjuster as claimed in claim 13, wherein the fastening receivers are configured such that the fastening elements are mounted so as to be limitedly linearly movable.

15. The longitudinal adjuster as claimed in claim 13, wherein the respective fastening receiver is designed to block the linear movement of the fastening element in one direction, and to allow a limited linear movement of the fastening element in a direction opposite thereto.

16. The longitudinal adjuster as claimed in claim 13, wherein the respective fastening receiver is configured as a slot.

17. The longitudinal adjuster as claimed in claim 13, wherein the at least two fastening receivers are oriented in the same way in the longitudinal direction.

18. The longitudinal adjuster as claimed in claim 11, wherein the spindle is connected via the spindle holder to an attachment plate.

19. The longitudinal adjuster as claimed in claim 11, wherein a spring element with predefined pretension is arranged between the spindle holder and the second rail.

20. A vehicle seat with a longitudinal adjuster as claimed in claim 11.
